(19) United States
(12) Patent Application Publication
(10) Pub. No.: US 2003/0014476 A1
(43) Pub. Date: Jan. 16, 2003

(54) Thin client computer operating system

(76) Inventor: David Allen Peterson, Tallahassee, FL (US)

Correspondence Address: MICHAEL J. COLITZ, III, HOLLAND & KNIGHTS LLP, 400 N. ASHLEY DRIVE, SUITE 2300, TAMPA, FL, 33602, US

(21) Appl. No.: 09/753,934

(22) Filed: Jan. 3, 2001

(51) Int. Cl. G06F 15/16

(52) U.S. Cl. 709/203

(57) ABSTRACT

There is disclosed a very thin operating system for a thin client computer operative in a client/server configuration. The operating system for the thin client computer is utilized only to boot the computer and control the peripheral drivers. The application software and the desktop for the thin client computer are downloaded from the server after the operating system boots the thin client computer. Because the thin operating system presents very low overhead to the data published from the server to the client, the data is operated upon quicker and the screen refresh rate is faster. As a result there is no noticeable screen redraw due to an insufficient screen refresh rate.

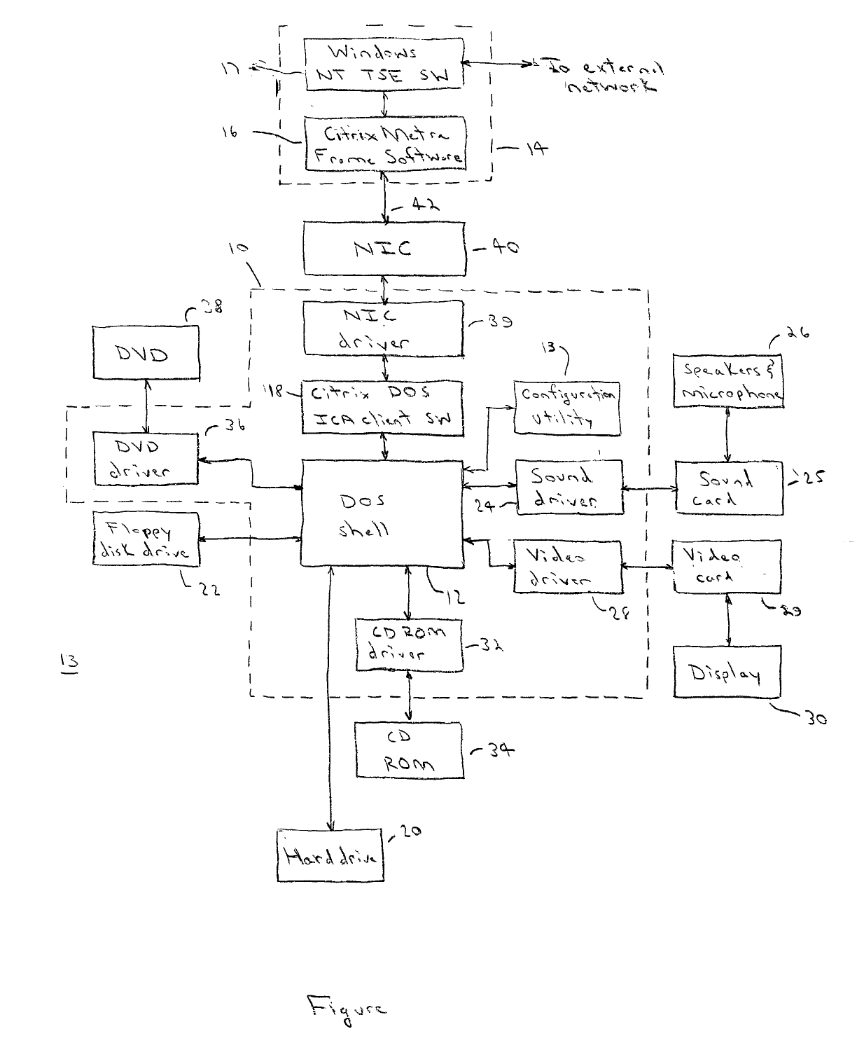

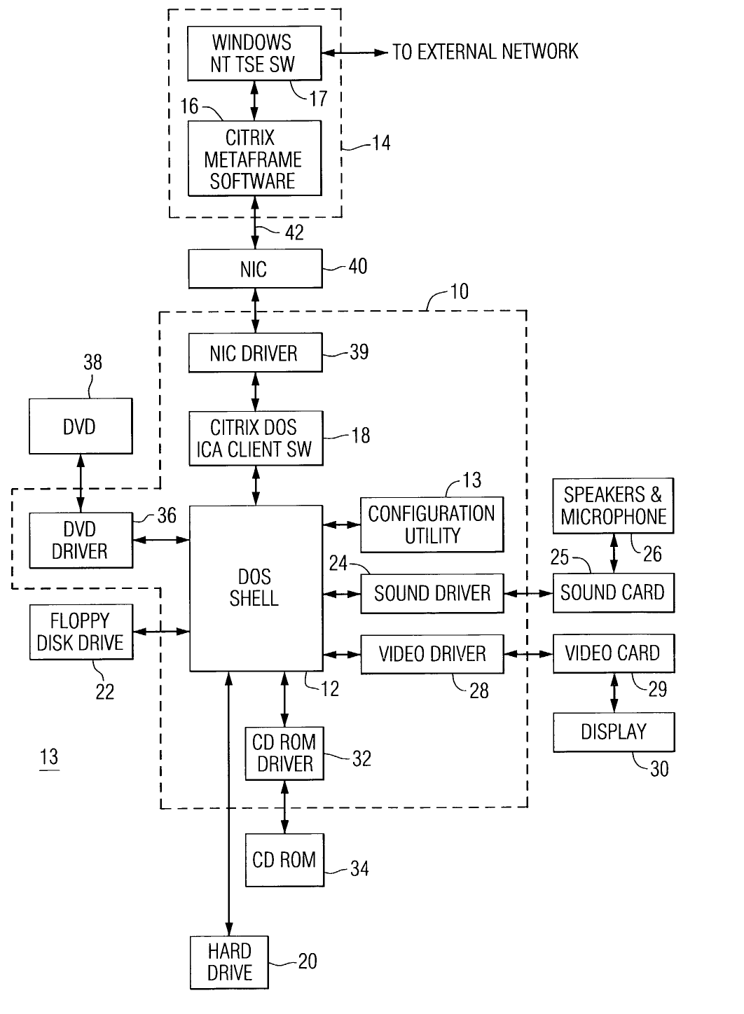

### BACKGROUND OF THE INVENTION

The present invention relates generally to computer operating systems, and more specifically, to a computer operating system and associated computer code (e.g. peripheral device drivers) for a so-called very thin computer.

Thin client and server-based computing is the fourth phase in the computer revolution that began with the mainframe computer. Mainframes are powerful computers that allowed organizations to tap into the power of information and information processing. Large organizations and companies used their mainframe computers to automate manual tasks, shorten the time to market for new products and run financial models for the business. However, these high-powered computers came with a high-price tag. The follow-on “mini-computer” carried a lower price tag than the mainframes computers, while offering mainframe-like capabilities for most processing tasks.

Today, mainframe computers continue to play an important role, especially in corporate computing, for several reasons, including: the massive computing power achieved in a single computer through symmetric multi-processing performed by a plurality of RISC-based (reduced instruction set computer) central processing units (CPUs); the unprecedented level of fault tolerance achieved through clustering a plurality of computers in a computing environment; and the ability to run enterprise wide business critical computer applications.

The mainframe-based system consists of a centralized computer, usually housed in a secure, climate controlled computer room, while users interface with the computer via so-called “dumb terminals.” Generally, the dumb terminals are relatively low cost and usually consist of a monitor, a keyboard and a communications port connected to the main frame computer. Initially, these terminals were hard-wired directly to communication ports on the main-frame computer and the communications occurred in an asynchronous mode. Today, the terminals are often connected to a network terminal server that is capable of connecting to multiple resources and mainframe computers on the network, thus giving the terminal users more flexibility. These dumb terminals are typically ASCII (American Standard Code for Information Interchange) character based devices and are sometimes referred to as “green screens.” Today, many personal computer (PC) users connect to mainframes through terminal emulators that provide the personal computer with the capabilities of a standard dumb terminal, in addition to its PC capabilities.

In a mainframe environment, all users depend on a single computer that can easily be centrally managed and maintained. The mainframe configuration has the additional advantage of being more secure, not only because of the physical security of the computer room, but also because users are unable to introduce viruses or other bugs into the system. But, because the mainframe's configuration requires time sharing of computer resources by all users, potential bottlenecks can develop.

The next step in the evolutionary development of computer use was the introduction of the personal computer with a graphical user interface, together with literally thousands of Windows® (a trademark of Microsoft Corporation) based applications that provide new levels of employee productivity in a user friendly environment. The wide adoption of personal computers in the enterprise environment has created a distributed computing situation where the CPU's enhanced computing power is extended out of the computer room to the users desk top. In this situation, the user is not dependent on the availability of the mainframe computer because most of the functions are now performed directly at the desktop computer. Unfortunately, the personal computer configuration is generally more expensive to operate and maintain than the main frame/dumb terminal configuration. Each personal computer must be managed and maintained, including hardware and software installation, upgrades, repairs and routine maintenance. The personal computer offers the advantages of standardized hardware and operating systems (typically related to the Windows operating system), a graphical user interface and considerable user flexibility. However, the desktops are considerably more expensive to maintain than the dumb terminals and the main frame computer. Some distributed computing environments also lack centralized backup and management of the computing system and present security risks associated with physical security, data access by unauthorized users and the introduction of viruses into the personal computer. Also, as processor speed increases and more applications become available, it is difficult for enterprises to maintain the latest technology at every desktop. As a result there is an never-ending cycle of desktop upgrades to provide users with the latest hardware devices to run the latest application software.

An intermediate step in the development of computer technology is the PC LAN (local area network) configuration or networked computer environment. In a PC LAN system there is typically a plurality of desktop computers (referred to as clients) and one or more servers for file, printer and application sharing. While such a system is casually referred to as a client/server system, true client/server computing is achieved only when application processing (e.g. a data base) is split between a client and a server. For example, in an SQL environment, the client issues a query across the communications network to the server. The server is the host of the SQL data base and it processes the query on behalf of the client. The results of the query are then returned to the client user across the network for analysis as required. This is in contrast to a non-client/server configuration where the source data itself is sent across the network to the client machine for query processing. The client/server computing model taps into the potential power of a high-end centralized personal computer, much like the mainframe model, but including a graphical user interface and state of the art software applications resident on the client. Client/server computing can also significantly reduce network load due to the execution of certain instructions and applications at the client, thereby decreasing the network traffic.

The client/server networked personal computer suffers from the same problems as the stand alone personal computer. Software is outdated almost as soon as it is made available. Hardware must be continually upgraded to support the ever more complex software applications. Additionally, the networked environment creates its own unique problems, including multiple versions of operating software and incompatible option cards on the networked computers.

The latest step in the computer system evolution is the thin client, using server-based technologies that shift more of the responsibility back to a high-powered highly reliable centralized system. This configuration also achieves a significant reduction in the total cost of ownership by deploying low cost and low maintenance devices to the desk top and once again centralizing the management of desktop functions.

Certain innovations within the computer industry have fostered and encouraged the development of thin client architectures. The objective of the thin client system is to provide users with access to all applications and information they need no matter where located and independent of the type of computer they are operating. These innovations include access to the Internet, intranets, webs, client/server applications and enterprise-wide networks. Notwithstanding the use of thin clients at the desktop, individual users still require access to personal productivity tools, electronic mail, emulators for legacy systems, network access and Internet and intranet access. Additionally, the thin client users require access to the common input/output devices (e.g., printer, keyboard, mouse, monitor). The thin client should also allow execution of higher-end memory intensive multimedia applications such as those used for photo enhancement, the preparation of slide presentations and publications, and the preparation of complicated drawings and schematics. Now that computer users have become accustomed to the availability of such input/output devices and the availability of high-end software programs on their individual desktops, it is critical that the thin client computer provide such features, while also attaining the advantages of the thin computer configuration as discussed above.

In the prior art, the power of a personal computer is measured, at least qualitatively, by the operating system employed. Microsoft Windows® Version 3.11 (a trademark of Microsoft Corporation) is the smallest Windows-based operating system. It supports only 16 bit functionality and is no longer supported by the vendor. Many of today's software applications cannot run under this legacy version of Windows. Microsoft Windows® 95 and 98 both provide 32 bit functionality and the latter supports the universal serial bus. But both are impose a large (the latter larger than the former) overhead on the computer system. Microsoft Windows 2000® is the latest version of the ubiquitous operating system. Microsoft Windows 2000 Server® is the latest server operating system, replacing Microsoft Windows NT® Version 4.0. (All trademarks of Microsoft Corporation or Redmond, Wash.) But Windows NT does not support multiple sessions by multiple clients unless supplemented by an add-on product called the Terminal Server Edition (TSE). Windows 2000 Server has the terminal server software built-in and supports 32 bit functionality. The Linux operating system is relatively small and reliable, but lacks compatibility with many older hardware devices and software applications. It also provides 32 bit functionality. The Macintosh operating system is a reliable operating system, but compatible only with Macintosh-based devices. The 16 bit version of DOS is very small (in terms of memory overhead), but does not provide full-color functionality nor sound support, and only limited support for network interfacing. Finally, Windows CE® (a trademark of Microsoft Corporation)does not support many conventional input/output devices.

Thus it can be seen that there is a need for an operating system for thin client computers that supports multiple input/output devices, operates with legacy hardware devices and software applications and uses minimal memory overhead resources. Only with such an operating system can the advantages of thin client computing be fully realized.

### SUMMARY OF THE INVENTION

The above-mentioned thin client or thin computer features are available through use of the very thin operating system (VTOS) of the present invention, which supports common input/output devices while minimizing the desktop-resident hardware and software components. The VTOS (which in one embodiment requires less than 8 MB of memory) also provides 32 bit coding to the video driver, thus allowing the monitor to display 16,000,000 colors. The thin client of the present invention is backward compatible with legacy hardware and software, but makes it possible to deliver to the user's desktop the full complement of features available on a typical personal computer, without the high cost and administrative burdens associated with those personal computers. The thin client computer splits application processing between the server and the client so that the applications are run on the latest high-performance servers while the graphics are originally vectored on the server (during the client's session) and secondarily redrawn on the client's display screen. The client's device refreshes the screen when no bitmaps are being modified, thus significantly reducing the network bandwidth. As the available software applications grow more powerful and complex, the servers can be upgraded to accommodate the new applications, without having to add memory, disk space or other resources to the thin client computer.

According to the teachings of the present invention, a simplified operating system is installed on the client computer. The operating system requires very low overhead, thereby allowing the software applications to execute with no visible slowdown. The very thin operating system of the present invention interacts with the server such that all applications are published to the desktop from the server, rather than residing on the desktop itself. The very thin operating system can be loaded on a lower-end or outdated personal computer or a thin client device with the VTOS operating system can be built.

The use of the VTOS renders it unnecessary to replace the client device whenever a new operating system, browser or terminal emulation package is released. Thus VTOS driven devices solve the problem of early obsolescence in the computer industry. No longer is it necessary to purchase the next generation of computer, which is faster, bigger and cheaper than the previous generation, to run the larger and slower, and more powerful, applications. Instead, only the server is upgraded, while the client devices remain unchanged.

Further, because the very thin operating system adds little overhead to device processing, there is sufficient processing time available to increase the video refresh rate on the display. As a result, the VTOS based display is comparable to the displays of high-end personal computers operating in a stand alone mode. Finally, the very thin operating system of the present invention supports all commonly available input/output devices.

### BRIEF DESCRIPTION OF THE DRAWINGS

The present invention can be more easily understood and the further advantages and uses thereof more readily apparent when considered in view of the description of the preferred embodiments and the FIGURE, which is a block diagram of a thin client computer constructed according to the teachings of the present invention.

### DETAILED DESCRIPTION OF THE PREFERRED EMBODIMENTS

Before describing in detail the particular thin client computer system in accordance with the present invention, it should be observed that the present invention resides primarily in a novel combination of steps and apparatus related to a computer system. Accordingly, the hardware components and method steps have been represented by conventional elements in the drawings, showing only those specific details that are pertinent to the present invention, so as not to obscure the disclosure with structural details that will be readily apparent to those skilled in the art having the benefit of the description herein.

A thin client computer constructed according to the teachings of the present invention allows higher-end resource intensive software applications to reside on and execute fully on a server and then to be published from the server to the thin client computer. The thin client computer comprises a DOS shell that interacts with server software to provide the functionality of the thin client computer. In one embodiment, the server software includes Microsoft Windows NT Terminal Server Edition or Windows 2000® Server. The server software further comprises Citrix Metaframe Version 1.8, for controlling the session between the thin client and the server. Before a session begins between the thin client computer and the server, a predetermined amount of memory is apportioned on the server computer for use by the thin computer.

The DOS shell-based operating system on the thin client is relatively small and therefore allows the resource intensive applications to execute without any obvious slowdown in execution time. (As will be discussed further hereinbelow, the operating system of the present invention is referred to as VTOS, a very thin operation system). Such multimedia applications as Microsoft Power Point Microsoft Front Page®, Microsoft PhotoDraw®, Adobe PhotoShop® and Davidson Mathblaster® (all trademarks of their respective owners) can be executed on the thin client computer of the present invention. Also, videos can be played without any noticeable differences between playback on the thin client computer versus playback on a fully functional Windows® based system. It has been found that running a highend multimedia application on a personal computer with a Windows operating system and Microsoft Windows NT Version 4.0 plus Citrix Metaframe™ Version 1.8 (a trademark of Citrix Systems) running on the server, slows the display process. This is due to the high overhead associated with the client Windows operation system.

However, this effect that does not occur when operating a thin client computer constructed according to the teachings of the present invention, again with Microsoft Windows NT Version 4.0 plus Citrix Metaframe Version 1.8 running on the server because the in one embodiment the DOS shell comprises less than 8 MB (and operates in a 32 bit mode) and therefore does not present significant operational overhead during program execution. As a result, all software applications, including resource intensive applications, execute with no noticeable slowdown in the execution or in the display processes. The DOS shell is based on DOS operating system and in one embodiment Microsoft DOS Version 6.22 forms the basis of the DOS shell, which is a key component of VTOS.

As is well known by those skilled in the art, in the prior art client/server configurations, both Microsoft Windows® NT Version 4.0 Terminal Server Edition and Windows 2000® typically run with a fully featured client operating system, such as Microsoft Windows V3.11®, Windows 95®, Windows 98®, Linux® or a MacIntosh®. (All trademarks of their respective owners.) These fully featured client operating systems allow the client to operate essentially on a stand alone basis, with the processing segregated between the client and the server, (and a significant share of the processing performed at the client), but also represent significant purchase and maintenance costs for each client computer. As software packages become more complex and thereby require additional hardware and software resources, the client operating system and/or the computer hardware must be upgraded to provide the additional functionality. It is, in fact, this stand alone fully-featured characteristic of the most popular operating systems that create the processing bottleneck when operating in a client/server mode.

In contrast, the DOS shell of the present invention is relatively simple, relying instead on the client software for control and execution of the application programs. Basically, the DOS shell provides the boot up functionality for the client software and controls the various input and output devices, as will be discussed further herein below. Advantageously, as additional hardware and functionality is required to execute more demanding software applications, in accordance with the present invention, it is not necessary to replace the DOS shell. Only the server software requires updating. Typically, a plurality of clients operate from the same server, and therefore expenses are significantly reduced when only the server software must be upgraded.

In most prior art client/server configurations, the desktop, (i.e., the graphical user interface observed and manipulated by the client user), some if not all drivers, an Internet browser and a terminal emulation program reside on the client computer. The remaining drivers (if the client supports other input/output devices) and the software applications are published to the client as needed. In accordance with the teachings of the present invention, VTOS provides for the publication of all applications and drivers to the client from the server. The only software resident on the client is the very thin operating system. As a result, it is generally unnecessary to replace the client hardware when a new operating system, browser, terminal emulation program or other application is released. Instead, the server is upgraded but the existing client devices can continue to be used with the upgraded server.

One significant advantage of the present invention is the increase in the apparent video refresh rate because of the significantly reduced overhead of the client operating system. Thus VTOS does not slowdown the video refresh process. Additionally, VTOS is a fully functional operating system that supports all aspects of input and output management. VTOS supports a floppy disk drive, a hard drive, a CD ROM, a DVD device, mouse, serial and parallel ports, a SCSI bus, and a universal serial bus. In essence, VTOS supports the same input/output devices that are supported by Windows 95®, Windows 98®, WFW and Windows 2000®. Legacy personal computers that perform either in a stand-alone or a client server environment typically support the same input and output devices, but only at the expense of a powerful and memory-intensive operating system. VTOS supports these input and output devices without that memory overhead penalty. Further WINDOWS CE®, which is the operating system of choice in may prior art thin client devices, does not support a floppy disk, a hard drive, a CD ROM, a DVD device or a SCSI bus. WINDOWS CE also consumes considerably more overhead memory than VTOS, which degrades the performance of a WINDOWS CE device when compared with a VTOS device. When a VTOS-based computer is turned on, it will not perform any functions until logged onto the server (farm). This feature represents an important security feature, especially in environments like schools, government, and business.

Turning to the FIGURE, there is shown a very thin operating system (VTOS) 10 and associated hardware devices, comprising a thin client computer 13. The VTOS 10 is controlled by a DOS shell 12, which consists of files and settings and together with the associated drivers and software resident on a server 14, which will be discussed further hereinbelow, controls operation of the thin client computer 13. However, as discussed above, the DOS shell 12 itself provides only limited control and functionality for the thin client computer 13. Most software applications and the desktop are published to the thin client computer 13 from the server 14. At boot up, the DOS shell 12 directs the thin client computer to the server 14 for operating instructions. Also, the DOS shell 12 identifies the type of sound card, network interface card, etc. that is resident on the thin client computer 13. Finally, the DOS shell 12 includes the code that allow the rendering of full color on the display.

The server 14 communicates with VTOS 10, specifically with the DOS shell 12, and includes Citrix Metaframe software 16 and Microsoft Windows NT Terminal Server Edition software 17. The thin client computer 13 also includes Citrix DOS ICA (Independent Computing Architecture) client software 18 for communicating with the DOS shell 12. Those skilled in the art recognize that other software programs are available to provide the functionality of the Citrix Metaframe software 16 and Microsoft Windows NT Terminal Server Edition software 17, so long as those software products support the ICA software on the thin client computer 13. The Citrix DOS ICA client software 18 interacts with the Citrix Metaframe software 16 to control the flow of data and executable code between the server 14 and the DOS shell 12. The process of loading applications, data and executable code from the server 14 to the DOS shell 12 is referred to generally as publishing the data from the server to the client. The server 14 also provides an interface to external networks, such as the Internet, as shown.

In operation the server 14 supports a number of simultaneous sessions with a plurality of thin client computers 13. Each thin client computer 13 operates in an independent and separate session on the server 14, and displays the screen changes that occur only within its session. The Citrix MetaFrame software 16 controls the individual sessions of the thin client computers 13. The Windows NT Terminal Server Edition software 17 provides the functionality to refresh the display of the thin client computer 13 at the refresh rate of the video card within the thin client computer 13. Typically, this refresh rate is 60,000 refreshes per second. But, the Citrix MetaFrame software 16 governs the display refresh rate and sends a refreshed screen to the thin client computer 13 only when there has been screen change (for example, the movement of mouse cursor or a keyboard entry).

In the prior art systems, once the refreshed screen bit map is received by the client computer, it must be processed by the operating system of the client. As discussed above, these prior art client operating systems impose a significant overhead on processing of data, including bit maps, and the result is a refresh rate below the 60.000 standard. According to the present invention and the very thin operating system 10 thereof, the bit map data is processed quicker, due to the smaller operating system, and therefore the refresh rate from the server 14 is very close to the standard of 60,000 refreshes per second. The difference in refresh rates is particularly noticeable to the user when running high performance multi-media software applications.

Under control of the Citrix Metaframe software 16 and the Citrix DOS ICA client software 18, applications and executable code are loaded onto a hard drive 20. The DOS shell 12 fetches data and code from the hard drive 20 as required to control the thin client computer 13 or as requested by the user. In accordance with the teachings of the present invention, the DOS shell 12 is capable of executing very few independent operations. The DOS shell supports the delivery of the log-on graphical user interface to the user and attaches to the primary domain controller. The DOS shell 12 also boots up the thin client computer 13 and interfaces with the various drivers for controlling the associated peripheral device. Even the graphical user interface (or the desktop) is not resident on the DOS shell 12, but instead is published to the DOS shell 12 from the server 14. As contrasted with fully featured operating systems, the DOS shell 12 functions only in a client/server environment. Whereas, most operating systems commonly used today function in an independent stand alone mode and in a client/server mode, as required by the system configuration. Because these prior art operating systems are designed to operate independently, they include many more lines of executable code, representing far more overhead than the DOS shell 12. Of course, they also provide greater independent computing power than the VTOS 10. As a result of this extra overhead, when operating in the client/server mode the high overhead operating system slows the display refresh rate, as discussed above.

As shown in the FIGURE, the DOS shell 12 interfaces and controls the hard drive 20 and a floppy disk drive 22 using the control information set forth in the basic instructions for the operating system (BIOS). Although not show in the FIGURE, the DOS shell 12 also supports a SCSI (small computer system interface) bus and a universal serial bus (USB). Further, the DOS shell 12 interfaces with a sound driver 24 (for controlling speakers and a microphone 26) a video driver 28 (for controlling a display 30), a CD ROM 32 (for controlling a CD ROM 34) and a DVD driver 36 (for controlling a digital video disk or DVD 38). The FIGURE also includes a network interface card 40 connected to a network 42 for accessing the server 14, which resides at the far end of the network 42. Although not shown in the FIGURE, VTOS also supports a keyboard, a mouse and data compression utilities.

Another component of the VTOS 10 is the configuration utility 15. This is a simple interface operative to control and configure the DOS shell 12, the network interface card 40 (including the configuration of various brands of network interface cards), the audio and video settings in the sound driver 24 and the video driver 28, settings within the Citrix DOS ICA client 18, (for instance, the client station identification and the file version settings), the IP addresses and IPX/SPX stack, the gateway settings and the subnet mask settings. The IP addresses, IPX/SPX stack, the gateway settings and the subnet mask settings are required in every network to manage and control the network interface. All of typical operating systems have a built-in dialog box that allows the user to input these settings. VTOS 10 includes a menu system that allows the user to input this information to the system.

The network driver 39 is DOS-based software and the particular driver utilized is dependent upon the characteristics of the network interface card 40. The NIC driver 39 manages the IPX/SPX stack, the TCP/IP protocols and the LAN manager for communicating with the server 14. The network interface card 40 is utilized in those configurations where access to the server 14 is available via a local area network. The thin client computer 13 can also include a modem (not shown in the FIGURE) for those installations where a network is not available and access to the server 14 is provided through the public switched telephone network.

The sound driver 24 and the associated sound card 25, the CD ROM driver 32 and the DVD driver 36 provide the settings and control for the associated peripheral device. The characteristics of these drivers are well known by those skilled in the art.

The video driver 28 is a 32 bit driver designed to provide full color functionality at the display 30, operating in conjunction with a video card 29, which supports a 32 bit video driver and can provide the plurality of colors called for by a 32 bit video driver, such as the video driver 28. The prior art DOS drivers support only 16 colors on the display 30. The 32 bit video driver 28 provides 16,000,000 colors on the display 30. The configuration of the very thin computer 13 also offers important security features unavailable with the fully featured operating systems. Since little code actually resides on the very thin computer 13, there is little opportunity for a user to accidentally or purposefully modify the operating system. Without connecting to the server, the user is unable to perform even simple tasks such as making a directory or changing a directory in the operating system. After logging into the server, the user is given access to his or her desktop and the privileges accorded to that user. The user can then perform functions within the limits of those privileges. Only if the user has permission to make a directory, for example, will the very thin computer 13 respond to such commands as entered by the user.

While the invention has been described with respect to a preferred embodiment, it will be understood by those skilled in the art that various changes may be made and equivalent elements may be substituted for elements of the invention without departing from the scope thereof. In addition, modifications may be made to the present invention to adapt it to a particular situation more material to the teachings of the present invention without department from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A thin client computer connected to a server computer having server software resident thereon, said thin client computer comprising:
a local storage device associated with the thin client computer for storing an operating system, wherein the operating system starts the thin client computer;
a display;
a downloading device for retrieving the desktop from the server computer, wherein the desktop is displayed on said display,
wherein the operating system and the server software control operation of the thin client computer by way of managing a session operative at the server; and
wherein the operating system supports input and output devices for the thin client computer.

2. The thin client computer of claim 1 wherein the operating system cannot alone operate the thin client computer.

3. The thin client computer of claim 1 wherein the connection to the server is made via a network interface card on the thin computer to a local area network.

4. The thin client computer of claim 1 wherein a predetermined amount of memory is apportioned on the server computer for the thin client computer when a session begins.

5. The thin client computer of claim 1 wherein the input and output devices are selected from among the group consisting of speakers, a microphone, a CD ROM, a hard drive, a floppy disk drive and a DVD drive.

6. The thin client computer of claim 1 wherein the display provides approximately 16,000,000 display colors.

7. The thin client computer of claim 1 wherein software applications are resident on the server computer and are published to the thin client computer for use by the thin client computer during an operating session.

8. The thin client computer of claim 1 wherein the server computer controls the display refresh process.

9. The thin client computer of claim 1 wherein input/output device drivers are resident on the server computer for use by the thin client computer during an operating session.

10. The thin client computer of claim 9 wherein the input/output device drivers are published to the thin client computer during an operating session.

11. The thin client computer of claim 1 further comprising a video driver for controlling the display, and wherein the video driver operates in a 32 bit mode.

12. A method for operating a thin client computer including a display, a plurality of input and output devices and an operating system stored on the thin client computer, wherein the thin client computer is connected to a server computer having server software resident thereon, said method comprising:
booting the thin client computer using the operating system;
retrieving the desktop from the server computer, wherein the desktop is displayed on the display,
controlling the thin client computer by managing a session between the thin client computer and the server computer; and
operating the input and output devices by way of the operating system.

13. The thin client computer of claim 12 wherein the operating system cannot alone operate the thin client computer.

14. The thin client computer of claim 12 wherein a predetermined amount of memory is apportioned on the server computer for the thin client computer when a session begins.

15. The thin client computer of claim 12 wherein the input and output devices are selected from among the group consisting of speakers, a microphone, a CD ROM, a hard drive, a floppy disk drive and a DVD drive.

16. The thin client computer of claim 12 further comprising a video driver for controlling the display, and wherein the video driver operates in a 32 bit mode to provide approximately 16,000,000 display colors.

17. The thin client computer of claim 12 wherein software applications are resident on the server computer for use by the thin client computer during an operating session.

18. The thin client computer of claim 17 wherein the software applications are published to the thin client computer during an operating session.

19. The thin client computer of claim 12 wherein input and output device drivers are resident on the server computer for use by the operating system during an operating session.

20. The thin client computer of claim 19 wherein the input and output device drivers are published to the thin client computer during an operating session.
